(19) United States
(12) Patent Application Publication
(10) Pub. No.: US 2014/0125741 A1
(43) Pub. Date: May 8, 2014

(54) LIQUID JET HEAD AND LIQUID JET APPARATUS

(71) Applicant: SII PRINTEK INC., Chiba (JP)

(72) Inventors: Satoshi HORIGUCHI, Chiba (JP); Yuki YAMAMURA, Chiba (JP); Yuzuru KUBOTA, Chiba (JP); Yoshinori DOMAE, Chiba (JP); Masatoshi TODA, Chiba (JP); Masao TACHIBANA, Chiba (JP)

(73) Assignee: SII PRINTEK INC., Chiba (JP)

(21) Appl. No.: 14/065,890

(22) Filed: Oct. 29, 2013

(30) Foreign Application Priority Data
Nov. 6, 2012 (JP) 2012-244675

(51) Int. Cl. B41J 2/175

(52) U.S. Cl. CPC B41J 2/175
USPC 347/85

(57) ABSTRACT

A liquid jet head is provided with an actuator substrate which is partitioned by elongated walls of piezoelectric body and has elongated grooves arrayed thereon so as to penetrate the substrate from an upper surface through a lower surface thereof, a cover plate which is attached to the substrate so as to cover upper surface openings of the grooves and has a liquid supply chamber which supplies liquid to the grooves, and a nozzle plate which is attached to the substrate so as to cover lower surface openings of the grooves and has nozzles communicating with the respective grooves. Drive electrodes are formed in strip form on side surfaces of the walls along the longitudinal direction thereof so as to be separated from the nozzle plate. The nozzle plate has a lower stiffness than the cover plate.

### BACKGROUND

1. Technical Field

The present invention relates to a liquid jet head that ejects liquid droplets onto a recording medium to perform recording and a liquid jet apparatus.

2. Related Art

Recently, there has been used a liquid jet head using an ink jet system that ejects ink droplets onto a recording paper or the like to record characters or figures thereon, or ejects a liquid material onto the surface of an element substrate to form a functional thin film thereon. In the ink jet system, liquid such as ink or a liquid material is guided from a liquid tank into a channel through a supply path, and pressure is applied to liquid filled in the channel to thereby eject the liquid from a nozzle that communicates with the channel. When ejecting liquid, characters or figures are recorded, or a functional thin film having a predetermined shape is formed by moving the liquid jet head or a recording medium.

JP 4658324 B2 describes an ink jet head 100 which includes a sheet of piezoelectric material having a plurality of grooves as ink channels formed thereon. FIGS. 9A and 9B are cross-sectional views of the ink jet head 100 described in JP 4658324 B2. FIG. 9A is a cross-sectional view in the longitudinal direction of the ink channels. FIG. 9B is a cross-sectional view in a direction perpendicular to the longitudinal direction of the ink channels. The ink jet head 100 has a three-layer structure including a cover 125, a PZT sheet 103 including a piezoelectric body, and a bottom cover 137. The cover 125 is provided with nozzles 127 for ejecting droplets of ink. A plurality of ink channels 107, each of which has a ship-like cross-sectional shape, is formed on the top surface of the PZT sheet 103. The ink channels 107 are formed in parallel in a direction perpendicular to the longitudinal direction thereof. Respective adjacent ones of the ink channels 107 are partitioned by side walls 113, which are subjected to a polarization treatment in the direction indicated by arrows P. Electrodes 115 are formed on the upper part of opposite channel-facing surfaces of the respective side walls 113, namely, on opposite side wall surfaces of the respective ink channels 107. That is, each of the side walls 113 is sandwiched between electrodes 115 formed on the side wall surfaces of two adjacent ink channels 107.

The ink channels 107 communicate with the respective nozzles 127. A supply duct 133 and a discharge duct 132 are formed on the bottom of the PZT sheet 103, and communicate with the respective ink channels 107 near opposite ends thereof. Ink is supplied to the ink channels 107 through the supply duct 133 in the direction indicated by arrows S, and discharged through the discharge duct 132. Recessed portions 129 are formed on the surface of the PZT sheet 103 near the right and left ends of each of the ink channels 107. Electrodes (not illustrated) are formed on the bottom surfaces of the respective recessed portions 129, and electrically connected to the electrodes 115 formed on the side wall surfaces of the ink channels 107. Connection terminals 134 are stored in the respective recessed portions 129, and electrically connected to the respective electrodes formed on the bottom surfaces of the recessed portions 129.

The ink jet head 100 operates in the following manner. When a driving signal is given from the connection terminals 134, the driving signal is applied to the electrodes 115 which sandwich a side wall 113 therebetween. Accordingly, the side wall 113 is deformed into a dogleg shape as indicated by broken lines due to thickness-shear deformation, which changes the capacity of the ink channel 107. Due to the change of the capacity, ink droplets are ejected from the nozzle 127. The ink jet head of this type is called a side shoot/through flow type ink jet head.

FIGS. 10A and 10B are explanatory drawings of a liquid droplet jet apparatus described in JP 5-77420 A. FIG. 10A is an assembly perspective view of a part of the liquid droplet jet apparatus (FIG. 1 of JP 5-77420 A), and FIG. 10B is a front cross-sectional view of a part of an array 201 (FIG. 3 of JP 5-77420 A). The array 201 of the liquid droplet jet apparatus is provided with a grooved plate 202 having a plurality of parallel ink flow paths 204, each of which is sandwiched between side walls 207, a lid 206 for closing the ink flow paths 204, and a pair of nozzle plates 208a and 208b respectively attached to the front faces of the lid 206 and the grooved plate 202. The nozzle plates 208a and 208b are separated from each other to form a slit 209. As illustrated in FIG. 10B, the array 201 includes a piezoelectric material, and a polarization treatment is performed on the array 201 in a polarization direction 228 which is perpendicular to the surface thereof. Electrodes 205a to 205e are formed on the inner surfaces of respective grooves which form the respective ink flow paths 204. Each of the electrodes 205a to 205e is connected to a driving LSI chip 216. A clock line 218, a data line 220, a voltage line 222, and an earth line 224 are connected to the driving LSI chip 216.

The liquid droplet jet apparatus operates in the following manner. The driving LSI chip 216 generates a potential difference, for example, between the electrode 205b and the electrode 205c, and between the electrode 205d and the electrode 205c. Accordingly, a side wall 207c and a side wall 207d which sandwich an ink flow path 204c therebetween are deformed into an inverted V-shape. As a result, the capacity of the ink flow path 204c changes, and liquid droplets are thereby ejected from the slit 209.

### SUMMARY

In the ink jet head 100 described in JP 4658324 B2, each of the electrodes 115 is formed on the upper half part of each of the side walls 113, the upper half part being adjacent to the cover 125. Therefore, when the cover 125 is made of a material having a high stiffness, the vibration of a side wall 113 is transmitted to the cover 125, and then leaks to adjacent side walls 113, thereby causing crosstalk. That is, when deforming both side walls 113 adjacent to an ink channel 107 to be driven into a dogleg shape, since the drive portions of the side walls 113 are located close to the cover 125, the vibration of the side walls 113 is transmitted to the cover 125, and then leaks to adjacent ink channels 107, thereby causing crosstalk. On the other hand, when the cover 125 is made of a material having a low stiffness, immediately after applying a driving signal to the electrodes 115, a large pressure is applied to a meniscus formed on the nozzle 127. Therefore, it is difficult to appropriately eject liquid droplets due to, for example, the separation of liquid droplets to be ejected. It is thought that these problems occur because the electrodes 115 are located close to the nozzle 127 or the cover 125. Further, when the cover 125 is made of a metal having electrical conductivity, short circuit between the electrodes 115 and the cover 125 disadvantageously may occur.

In JP 5-77420 A, each of the electrodes 205 is formed on the entire side and bottom surfaces of the groove of each of the ink flow paths 204 formed on the grooved plate 202. The groove of this type is formed to have a width in the range of 50 μm to 100 μm and a depth in the range of 300 μm to 400 μm. However, in this case, when forming the electrodes 205 by sputtering or vapor deposition, the deposition rate of a metal material onto the wall surface near the bottom and the bottom surface of each of the grooves is low. As a result, mass productivity is largely deteriorated. Further, the electrodes can be formed by plating. However, to employ an electrode structure in which electrodes on both side surfaces of a groove are separated from each other and ejection is thereby independently performed through each ink flow path, it is necessary to separate the electrodes one by one by applying a laser beam onto the bottom surface of each of the grooves, which results in the deterioration of mass productivity. Further, when changing the ink jet head into a side shoot ink jet head by providing a nozzle in the lid 206, since the electrodes 205 and the lid 206 are located close to each other, the same problem as that in JP 4658324 B2 may occur.

The present invention has been made in view of the above problems, and is directed to providing a liquid jet head and a liquid jet apparatus capable of appropriately ejecting liquid droplets.

A liquid jet head of a first aspect of the present invention includes an actuator substrate that is partitioned by elongated walls of piezoelectric body and has a plurality of elongated grooves arrayed thereon so as to penetrate the actuator substrate from an upper surface through a lower surface thereof, a cover plate that is attached to the actuator substrate so as to cover upper surface openings of the grooves and has a liquid supply chamber that supplies liquid to the grooves, and a nozzle plate that is attached to the actuator substrate so as to cover lower surface openings of the grooves and has nozzles communicating with the respective grooves. Drive electrodes are formed in strip form on side surfaces of the walls along the longitudinal direction thereof so as to be separated from the nozzle plate. The nozzle plate has a lower stiffness than the cover plate.

A material of the nozzle plate has a lower stiffness than a material of the cover plate.

The nozzle plate includes a material having a Young's modulus in the range of 1.5 GPa to 30 GPa.

The cover plate includes a material having a Young's modulus of not less than 40 GPa.

The cover plate has a thickness in the range of 0.3 mm to 1.0 mm, and the nozzle plate has a thickness in the range of 0.01 mm to 0.1 mm.

The nozzle plate has a laminate structure of a polyimide film and a reinforcing plate having a higher stiffness than the polyimide film.

The cover plate includes a liquid discharge chamber that discharges liquid from the grooves. The liquid discharge chamber communicates with each of the grooves on one side in the longitudinal direction thereof, and the liquid supply chamber communicates with each of the grooves on the other side in the longitudinal direction thereof.

The grooves include an ejection groove and a non-ejection groove which are alternately arrayed. The liquid supply chamber communicates with the ejection groove and does not communicate with the non-ejection groove.

The grooves include an ejection groove and a non-ejection groove which are alternately arrayed. The liquid discharge chamber communicates with the ejection groove and does not communicate with the non-ejection groove.

A liquid jet apparatus according to an embodiment of the present invention includes the liquid jet head of the first aspect of the present invention, a movement mechanism that relatively moves the liquid jet head and a recording medium, a liquid supply tube that supplies liquid to the liquid jet head, and a liquid tank that supplies the liquid to the liquid supply tube.

The liquid jet head according to an embodiment of the present invention includes an actuator substrate that is partitioned by elongated walls of piezoelectric body and has a plurality of elongated grooves arrayed thereon so as to penetrate the actuator substrate from an upper surface through a lower surface thereof, a cover plate that is attached to the actuator substrate so as to cover upper surface openings of the grooves and has a liquid supply chamber that supplies liquid to the grooves, and a nozzle plate that is attached to the actuator substrate so as to cover lower surface openings of the grooves and has nozzles communicating with the respective grooves. Drive electrodes are formed in strip form on side surfaces of the walls along the longitudinal direction thereof so as to be separated from the nozzle plate. The nozzle plate has a lower stiffness than the cover plate. Accordingly, it is possible to provide a liquid jet head capable of appropriately ejecting liquid droplets.

### BRIEF DESCRIPTION OF THE DRAWINGS

FIG. 1 is an exploded perspective view of a liquid jet head according to a first embodiment of the present invention;

FIGS. 2A to 2C are explanatory drawings of the liquid jet head according to the first embodiment of the present invention;

FIG. 3 is a graph of the pressure response of a nozzle at the position of a meniscus when changing the positions of drive electrodes formed on walls in the depth direction thereof;

FIGS. 4(G1) to 4(G3) are cross-sectional schematic views of an ejection groove of the liquid jet head in the longitudinal direction thereof;

FIGS. 5A and 5B are cross-sectional schematic views of a liquid jet head according to a second embodiment of the present invention;

FIG. 6 is a cross-sectional schematic view of a liquid jet head according to a third embodiment of the present invention in a groove arraying direction;

FIGS. 7A and 7B are cross-sectional schematic views of a liquid jet head according to a fourth embodiment of the present invention;

FIG. 8 is a schematic perspective view of a liquid jet apparatus according to a fifth embodiment of the present invention;

FIGS. 9A and 9B are cross-sectional views of a conventionally-known ink jet head; and

FIGS. 10A and 10B are explanatory drawings of a conventionally-known liquid jet apparatus.

### DETAILED DESCRIPTION

### First Embodiment

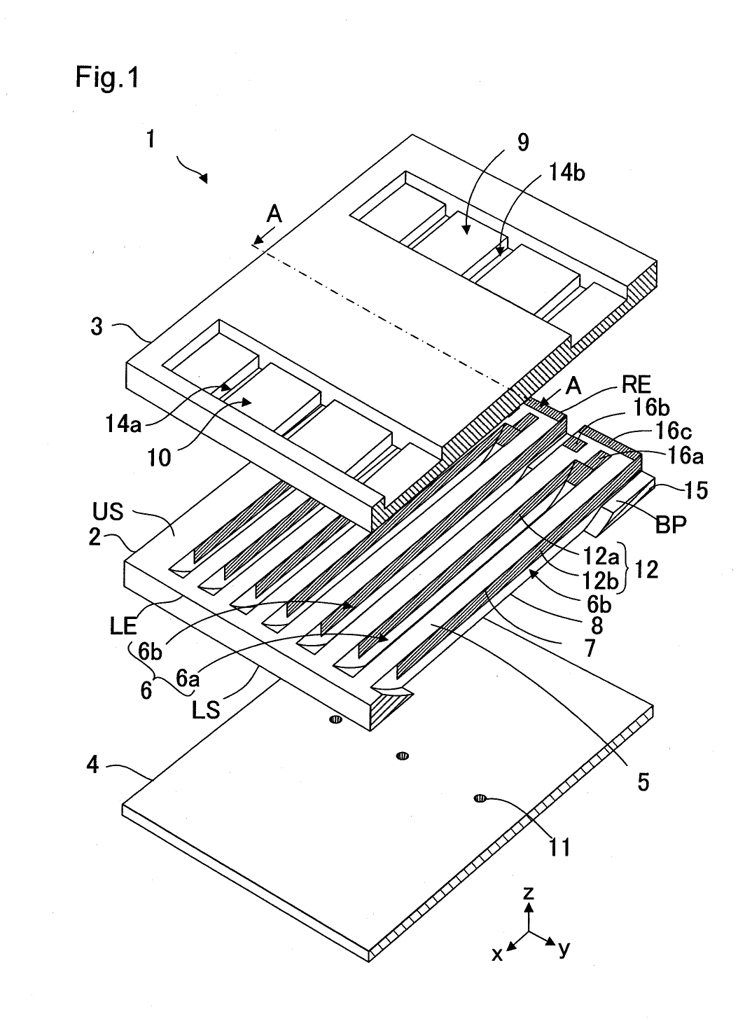

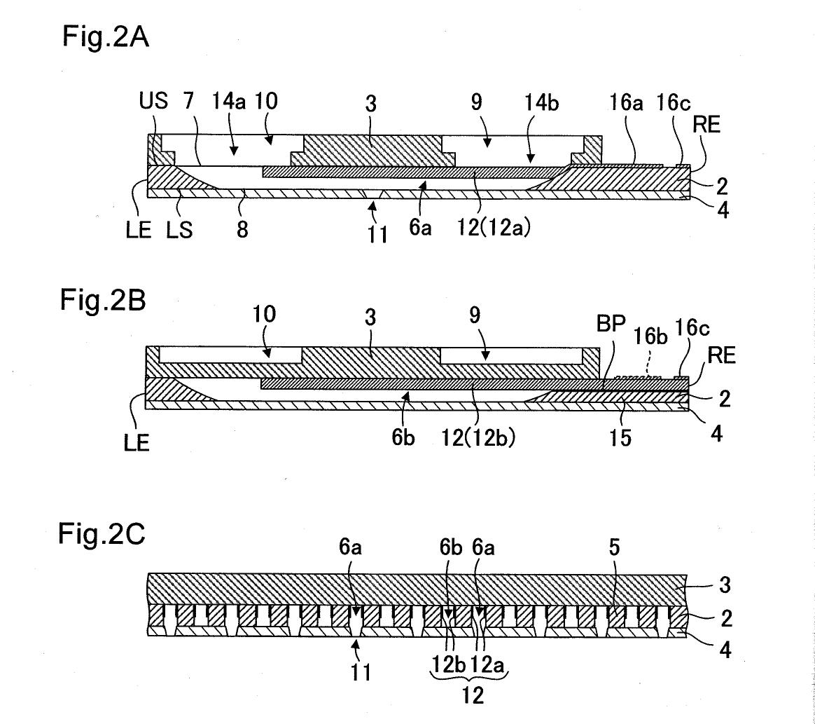

FIG. 1 is an exploded perspective view of a liquid jet head 1 according to the first embodiment of the present invention. FIGS. 2A to 2C are explanatory drawings of the liquid jet head 1 according to the first embodiment of the present invention. FIG. 2A is a cross-sectional schematic view of an ejection groove 6a in the longitudinal direction thereof. FIG. 2B is a cross-sectional schematic view of a non-ejection groove 6b in the longitudinal direction thereof. FIG. 2C is a cross-sectional schematic view taken along line A-A of FIG. 1. In the present embodiment, the liquid jet head 1 is of a side shoot/through flow type.

As illustrated in FIGS. 1 and 2A to 2C, the liquid jet head 1 is provided with an actuator substrate 2, a cover plate 3 attached to an upper surface US of the actuator substrate 2, and a nozzle plate 4 attached to a lower surface LS of the actuator substrate 2. The actuator substrate 2 is partitioned by walls 5 of piezoelectric body. A plurality of grooves 6 is arrayed in the actuator substrate 2. Each of the grooves 6 penetrates the actuator substrate 2 from the upper surface US through the lower surface LS and is elongated in the surface direction of the upper surface US or the lower surface LS. The cover plate 3 is attached to the actuator substrate 2 so as to cover upper surface openings 7 of the grooves 6, and has a liquid supply chamber 9 which supplies liquid to the ejection grooves 6a. The nozzle plate 4 is provided with nozzles 11 which communicate with the respective ejection grooves 6a, and attached to the actuator substrate 2 so as to cover lower surface openings 8 of the grooves 6. Drive electrodes 12 are formed in strip form on side surfaces of the walls 5 along the longitudinal direction thereof so as to be separated from the nozzle plate 4. The nozzle plate 4 has a lower stiffness than the cover plate 3.

Hereinbelow, a more detailed description will be made. The grooves 6 formed on the actuator substrate 2 include the ejection grooves 6a and the non-ejection grooves 6b. The ejection grooves 6a and the non-ejection grooves 6b are alternately arrayed in parallel in a direction (y direction) perpendicular to the longitudinal direction (x direction) of the grooves 6. In each of the ejection grooves 6a, one end positioned at a first side (hereinbelow, referred to as the first end) and the other end positioned at a second side (hereinbelow, referred to as the second end) in the longitudinal direction thereof are inclined outward from the lower surface LS toward the upper surface US of the actuator substrate 2. In the following description, each of “the first side” and “the second side” referred to in respective components indicates the same side in all of the components. Each of the ejection grooves 6a is formed from a position before a peripheral end LE of the actuator substrate 2 positioned at the first side (hereinbelow, referred to as a first-side peripheral end LE) up to a position before a peripheral end RE of the actuator substrate 2 positioned at the second side (hereinbelow, referred to as a second-side peripheral end RE) as well as before an end of the cover plate 3. In each of the non-ejection grooves 6b, one end in the longitudinal direction thereof positioned at the first side (first end) is inclined outward from the lower surface LS toward the upper surface US in the same manner as in the ejection grooves 6a, and the other end in the longitudinal direction thereof positioned at the second side (second end) extends up to the second-side peripheral end RE of the actuator substrate 2. Near the second-side peripheral end RE of the actuator substrate 2, raised bottom portions 15, each of which is the remainder of the actuator substrate 2, are formed on the bottoms of the non-ejection grooves 6b at the second end thereof. One end of each of the raised bottom portions 15 is inclined outward from the lower surface LS of the actuator substrate 2 toward an upper surface BP of the raised bottom portion 15 in the same direction as in the second end of each of the ejection grooves 6a.

The drive electrodes 12 include common electrodes 12a formed on the side surfaces of the ejection grooves 6a and active electrodes 12b formed on the side surfaces of the non-ejection grooves 6b. The common electrodes 12a are formed in strip form on side surfaces, the side surfaces facing the ejection grooves 6a, of the walls 5 along the longitudinal direction thereof, and electrically connected to each other. The active electrodes 12b are formed in strip form on side surfaces, the side surfaces facing the non-ejection grooves 6b, of the walls 5 along the longitudinal direction thereof, and electrically separated from each other. The common electrodes 12a and the active electrodes 12b are arranged at a depth that is separated from the nozzle plate 4 constituting the bottom surfaces of the ejection grooves 6a and the non-ejection grooves 6b, that is, arranged at upper positions so as not to reach the upper surfaces BP of the raised bottom portions 15. Further, each of the common electrodes 12a is arranged from a position before the first end of each of the ejection grooves 6a up to the second end thereof. Each of the active electrodes 12b is arranged from a position before the first end of each of the non-ejection grooves 6b up to the second end thereof.

On the upper surface US of the actuator substrate 2, there are arranged, near the second-side peripheral end RE, common terminals 16a which are electrically connected to the respective common electrodes 12a, active terminals 16b which are electrically connected to the respective active electrodes 12b, and wirings 16c each of which electrically connects active electrodes 12b formed on adjacent non-ejection grooves 6b. The common terminals 16a and the active terminals 16b are lands connected to a wiring electrode on a flexible substrate (not illustrated). Each of the active terminals 16b is electrically connected to an active electrode 12b that is formed on the side surface of one of two walls 5 that sandwich an ejection groove 6a therebetween, the side surface facing a non-ejection groove 6b. Further, the active terminal 16b is electrically connected to an active electrode 12b that is formed on the side surface of the other one of the two walls 5, the surface facing a non-ejection groove 6b, via a wiring 16c formed along the second-side peripheral end RE.

The cover plate 3 is provided with a liquid discharge chamber 10 at the first side of the actuator substrate 2 and the liquid supply chamber 9 at the second side thereof. The cover plate 3 is adhered to the upper surface US of the actuator substrate 2 with adhesive so that the ejection grooves 6a are closed, and the common terminals 16a and the active terminals 16b are exposed. The liquid supply chamber 9 communicates with the second ends of the ejection grooves 6a via second slits 14b, and does not communicate with the non-ejection grooves 6b. The liquid discharge chamber 10 communicates with the first ends of the ejection grooves 6a via first slits 14a, and does not communicate with the non-ejection grooves 6b. The nozzle plate 4 is adhered to the lower surface LS of the actuator substrate 2 with adhesive. The nozzles 11 which communicate with the respective ejection grooves 6a are positioned at substantially the center of the nozzle plate 4 in the longitudinal direction thereof. Therefore, liquid supplied to the liquid supply chamber 9 flows into the ejection grooves 6a via the second slits 14b, and is discharged into the liquid discharge chamber 10 via the first slits 14a. On the other hand, since the non-ejection grooves 6b do not communicate with the liquid supply chamber 9 and the liquid discharge chamber 10, liquid does not flow into the non-ejection grooves 6b.

As the actuator substrate 2, a piezoelectric material, for example, PZT ceramics on which a polarization treatment is performed in a direction perpendicular to the upper surface thereof can be used. As the cover plate 3, PZT ceramics which is the same material as the actuator substrate 2, machinable ceramics, other kinds of ceramics, and a low dielectric material such as glass can be used. When the same material is used as the cover plate 3 and the actuator substrate 2, thermal expansion can be made equal in the cover plate 3 and the actuator substrate 2 to prevent the occurrence of warpage or deformation caused by temperature variation. As the nozzle plate 4, a polyimide film, a polypropylene film, other synthetic resin films, a metal film, and the like can be used. The thickness of the cover plate 3 is preferably in the range of 0.3 mm to 1.0 mm. The thickness of the nozzle plate 4 is preferably in the range of 0.01 mm to 0.1 mm. When the cover plate 3 is thinner than 0.3 mm, the strength thereof is reduced. On the other hand, when the cover plate 3 is thicker than 1.0 mm, it takes time for the processing of the liquid supply chamber 9 and the liquid discharge chamber 10, and the first and second slits 14a and 14b. In addition, the manufacturing cost increases due to the increased amount of materials. Further, when the nozzle plate 4 is thinner than 0.01 mm, the strength thereof is reduced. On the other hand, when the nozzle plate 4 is thicker than 0.1 mm, vibration is transmitted between nozzles that are adjacent to each other, and crosstalk is thereby likely to occur.

The Young's modulus of PZT ceramics is 58.48 GPa, and the Young's modulus of polyimide is 3.4 GPa. Therefore, when PZT ceramics is used as the cover plate 3, and a polyimide film is used as the nozzle plate 4, the cover plate 3 which covers the upper surface US of the actuator substrate 2 has a higher stiffness than the nozzle plate 4 which covers the lower surface LS of the actuator substrate 2. The material of the cover plate 3 preferably has a Young's modulus of not less than 40 GPa. The material of the nozzle plate 4 preferably has a Young's modulus in the range of 1.5 GPa to 30 GPa. When the nozzle plate 4 has a Young's modulus of less than 1.5 GPa, the nozzle plate 4 bruises easily when making contact with a recording medium, and the reliability thereof is therefore reduced. On the other hand, when the nozzle plate 4 has a Young's modulus of more than 30 GPa, vibration is transmitted between nozzles that are adjacent to each other, and crosstalk is thereby likely to occur.

The liquid jet head 1 operates in the following manner. Liquid is supplied to the liquid supply chamber 9, and discharged from the liquid discharge chamber 10, thereby circulating liquid. Further, a driving signal is applied to the common terminal 16a and the active terminal 16b to thereby cause thickness-shear deformation of the walls 5 that form the ejection groove 6a. At this time, the walls 5 are deformed into an inverted V-shape as in JP 5-77420 A, or deformed into a dogleg shape as in JP 4658324 B2. Accordingly, a pressure wave is generated in liquid inside the ejection groove 6a, and liquid droplets are thereby ejected from the nozzle 11 that communicates with the ejection groove 6a. In the present embodiment, since the active electrodes 12b formed on the side surfaces of the walls 5 that form the respective non-ejection grooves 6b are electrically separated from each other, each of the ejection grooves 6a can be independently driven. By independently driving each of the ejection grooves 6a, high-frequency driving can be advantageously performed. The function of the liquid discharge chamber 10 and the function of the liquid supply chamber 9 may be reversed, that is, liquid may be supplied from the liquid discharge chamber 10 and discharged from the liquid supply chamber 9. Further, protection films can be formed on inner walls with which liquid makes contact.

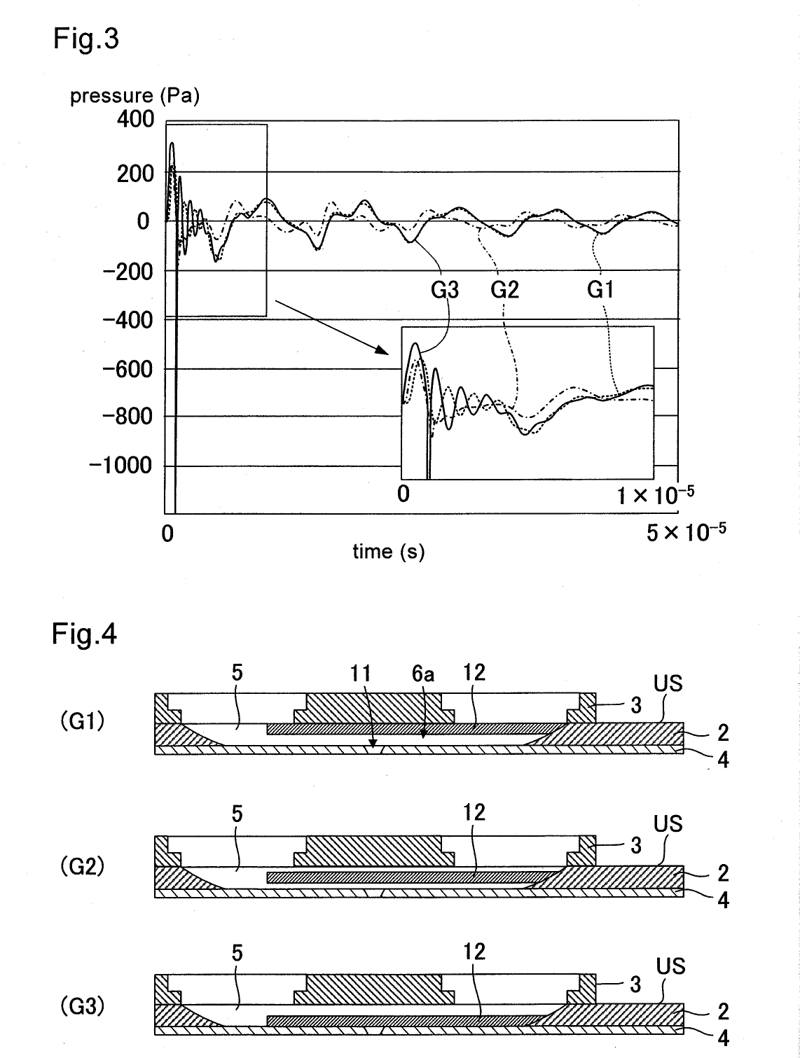

In this manner, by reducing the stiffness of the nozzle plate 4 so as to be lower than the stiffness of the cover plate 3, vibration of the walls 5 that sandwich an ejection groove 6a therebetween is not transmitted to adjacent ejection grooves 6a via the nozzle plate 4. Therefore, it is possible to prevent the occurrence of crosstalk which causes deterioration in the recording quality. Further, since the drive electrodes 12 (the common electrodes 12a and the active electrodes 12b) are separated from the nozzle plate 4, it is possible to prevent the generation of an abnormal pressure wave, and therefore normally eject liquid droplets. The abnormal pressure wave will be described in detail below with reference to FIG. 3.

The present invention is not limited to the configurations of the non-ejection grooves 6b and the active electrodes 12b described above. For example, the shape of the non-ejection grooves 6b may be the same as the shape of the ejection grooves 6a, and the active electrodes 12b which are formed on both side surfaces of the respective non-ejection grooves 6b may be electrically separated from each other. However, as in the present embodiment, when each of the non-ejection grooves 6b is provided so as to extend from the position before the first-side peripheral end LE of the actuator substrate 2 up to the second-side peripheral end RE thereof, and each of the active electrodes 12b is formed at the depth not to reach the upper surface BP of the raised bottom portion 15 as well as from the position before the first end of the non-ejection groove 6b up to the second-side peripheral end RE of the actuator substrate 2, the manufacturing process steps are simplified. That is, it is possible to collectively form the common electrodes 12a and the active electrodes 12b at once by an oblique deposition method.

FIG. 3 is a graph of the pressure response of a nozzle at the position of a meniscus when changing the positions, in the depth direction, of the drive electrodes 12 formed on the walls. An enlarged graph illustrating the pressure response from the point at which a driving signal is applied until the point after 1×10⁻⁵ seconds has passed is inserted into the lower right of FIG. 3. FIGS. 4(G1) to 4(G3) are cross-sectional schematic views of an ejection groove 6a of the liquid jet head 1 in the longitudinal direction thereof. FIG. 4(G1) is a view of a state where the drive electrode 12 is formed at the upper half part of the ejection groove 6a in the depth direction thereof. FIG. 4(G2) is a view of a state where the drive electrode 12 has a width approximately half the depth of the ejection groove 6a and is formed at the center of the ejection groove 6a in the depth direction thereof. FIG. 4(G3) is a view of a state where the drive electrode 12 is formed at the lower half part of the ejection groove 6a in the depth direction thereof.

In FIG. 3, the horizontal axis represents time (s), and the vertical axis represents the pressure (Pa) in a nozzle 11 at the position of a meniscus. In the graph of FIG. 3, a broken line G1 represents the pressure response when each of the drive electrodes 12 is arranged at the upper half part of the ejection groove 6a in the depth direction thereof as illustrated in FIG. 4(G1). Further, a dot chain line G2 represents the pressure response when each of the drive electrodes 12 is arranged at the position approximately half the depth of the ejection grooves 6a, that is, at the center in the depth direction thereof as illustrated in FIG. 4(G2). Further, a solid line G3 represents the pressure response when each of the drive electrodes 12 is arranged at the lower half part of the ejection groove 6a in the depth direction thereof as illustrated in FIG. 4(G3). Each of the lines G1 to G3 represents the result of simulation based on each of the liquid jet heads illustrated in FIGS. 4(G1) to 4(G3).

As is clear from FIG. 3 and the inserted graph in FIG. 3, in the solid line G3, the pressure drops to −1000 Pa or lower during 1 μs to 2 μs immediately after a driving signal is applied, that is, an abnormal wave is generated, and the pressure vibrates within the range of ±200 Pa thereafter. This is because, since the drive electrodes 12 formed on the side surfaces of the walls 5 are arranged near the nozzle plate 4, the deformation of the walls 5 is directly transmitted to liquid in the nozzle 11. On the other hand, in the broken line G1 and the dot chain line G2, the abnormal wave, in which the pressure largely drops to a negative pressure immediately after the driving voltage is applied, does not occur. This is because the drive electrodes 12 are separated from the nozzle plate 4 in the electrode structure illustrated in each of FIGS. 4(G1) and 4(G2).

When the abnormal wave is applied to the meniscus in the nozzle 11 immediately after the driving signal is applied as illustrated in the line G3, a change in state such as the separation of liquid droplets ejected from the nozzle 11 or the generation of satellite droplets formed by continuous liquid droplets occurs. As a result, stable recording on a recording medium cannot be performed. On the other hand, in the lines G1 and G2, such a problem has been solved. Therefore, it is preferred to separate the drive electrodes 12 from the nozzle plate 4. For example, as illustrated in FIG. 4(G2), each of the drive electrodes 12 is desirably formed at a part of the side surface of the ejection groove 6a, the part being at least shallower than three-quarters of the depth of the ejection grooves 6a from the upper surface US of the actuator substrate 2. In this case, the drive electrode 12 may be formed in strip form so as to totally cover a part of the side surface of the ejection groove 6a, the part being positioned above three-quarters of the depth of the ejection grooves 6a, or may also be formed in strip form so as to have a predetermined width as illustrated in FIG. 4(G2). By separating the drive electrodes 12 from the nozzle plate 4, even when the nozzle plate 4 is formed of, for example, a metal member having electrical conductivity such as stainless steel, short circuit between the drive electrodes 12 and the nozzle plate 4 can advantageously be prevented.

### Second Embodiment

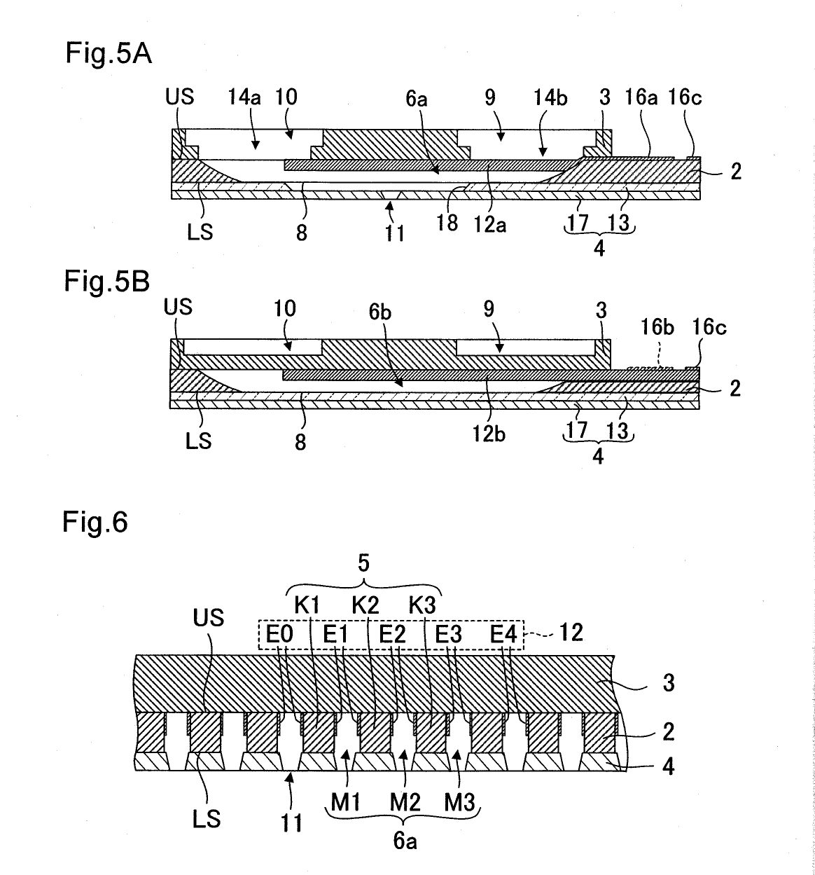

FIGS. 5A and 5B are cross-sectional schematic views of a liquid jet head 1 according to the second embodiment of the present invention. FIG. 5A is a cross-sectional schematic view of an ejection groove 6a in the longitudinal direction thereof. FIG. 5B is a cross-sectional schematic view of a non-ejection groove 6b in the longitudinal direction thereof. The difference from the first embodiment is that a nozzle plate 4 is configured to have multiple layers. The other configurations are the same as those of the first embodiment. Therefore, hereinbelow, only differences from the first embodiment will be described, and the descriptions of the same points will be omitted. The same components or components having the same function are denoted by the same signs as those in the first embodiment.

As illustrated in FIGS. 5A and 5B, the nozzle plate 4 has a laminate structure of a polyimide film 17 and a reinforcing plate 13 having a higher stiffness than the polyimide film 17. The reinforcing plate 13 is adhered to a lower surface LS of an actuator substrate 2 so as to cover lower surface openings 8 of the actuator substrate 2. The reinforcing plate 13 has through holes 18 which communicate with the respective lower surface openings 8 of the ejection grooves 6a. The polyimide film 17 is adhered to the reinforcing plate 13 on a side opposite to the actuator substrate 2. Nozzles 11 which communicate with the respective through holes 18 are formed in the polyimide film 17. An opening portion of each of the through holes 18 of the reinforcing plate 13 is formed to have a size close to the size of the lower surface opening 8 so as to prevent air bubbles from accumulating on the side surface of the opening portion.

As the reinforcing plate 13, a synthetic resin or a metal film can be used. A material having a Young's modulus in the range of 1.5 GPa to 30 GPa is preferably used as the reinforcing plate 13. However, a material having a Young's modulus of more than 30 GPa such as a metal film can be used as long as the average Young's modulus of the nozzle plate 4 is within the range of 1.5 GPa to 30 GPa. Further, also in the nozzle plate 4 having a laminate structure, the overall thickness thereof is preferably set in the range of 0.01 mm to 0.1 mm.

### Third Embodiment

FIG. 6 is a cross-sectional schematic view of a liquid jet head 1 according to the third embodiment of the present invention in a groove arraying direction. The difference from the first embodiment is that the non-ejection grooves 6b are replaced with the ejection grooves 6a, and an ejection operation is performed by three-cycle driving described below. The other configurations are substantially the same as those of the first embodiment. Therefore, hereinbelow, only differences from the first embodiment will be described, and the descriptions of the same points will be omitted. The same components or components having the same function are denoted by the same signs as those in the first embodiment.

An actuator substrate 2 has a plurality of elongated ejection grooves 6a (M1 to M3) arrayed thereon, each of the ejection grooves penetrating the actuator substrate 2 from the upper surface US through the lower surface LS thereof. A cover plate 3 is provided with a liquid discharge chamber at the first side of the actuator substrate 2 and a liquid supply chamber at the second side thereof. The liquid supply chamber communicates with the second ends of the ejection grooves 6a via first slits, and communicates with the first ends of the ejection grooves 6a via second slits. A nozzle plate 4 is provided with nozzles 11 which communicate with the respective ejection grooves 6a. Further, on both side surfaces of the respective ejection grooves 6a, drive electrodes 12 (E0 to E4) are formed in strip form along the longitudinal direction of the ejection grooves 6a. The drive electrodes 12 on the side surfaces of the ejection grooves 6a are arranged at a depth that is separated from the nozzle plate 4 constituting the bottom surfaces of the ejection grooves 6a. Since the stiffness and thickness of each of the nozzle plate 4 and the cover plate 3 are the same as those of the first embodiment, descriptions thereof will be omitted.

In the cover plate 3, the liquid supply chamber and the liquid discharge chamber may be formed so as to penetrate the actuator substrate 2 from the upper surface US through the lower surface LS thereof without providing the first and second slits. When the liquid supply chamber and the liquid discharge chamber are made to penetrate the actuator substrate 2, the manufacturing process steps are reduced. On the other hand, when the first and second slits are formed, since the upper surfaces US of all of the walls 5 (K1 to K3) are adhered to the cover plate 3, the connection between the walls 5 and the cover plate 3 is reinforced, and the strength of the ejection grooves 6a is thereby improved.

The liquid jet head 1 operates in the following manner. Liquid is supplied to the liquid supply chamber, and discharged from the liquid discharge chamber, thereby circulating liquid. When driving the ejection groove M1, a driving signal is applied between the drive electrodes E1 and E0 and between the drive electrodes E1 and E2 to thereby cause thickness-shear deformation in the wall K1 and the wall K2. Accordingly, the capacity of the ejection groove M1 changes, and liquid droplets are thereby ejected from the nozzle 11 that communicates with the ejection groove M1. Thereafter, three-cycle driving is sequentially performed with respect to the ejection grooves M2, M3, M1, M2, M3, M1 . . . in this order. As a result, it is possible to eject liquid droplets from all of the ejection grooves 6a.

### Fourth Embodiment

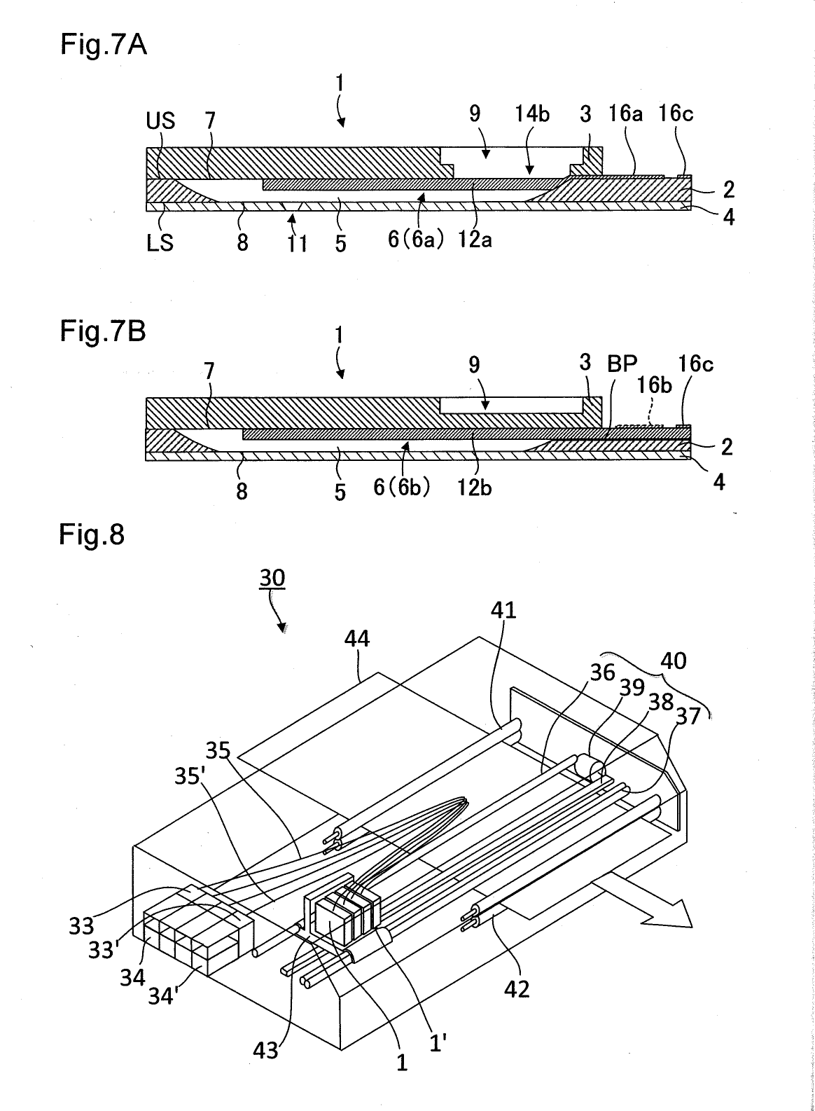

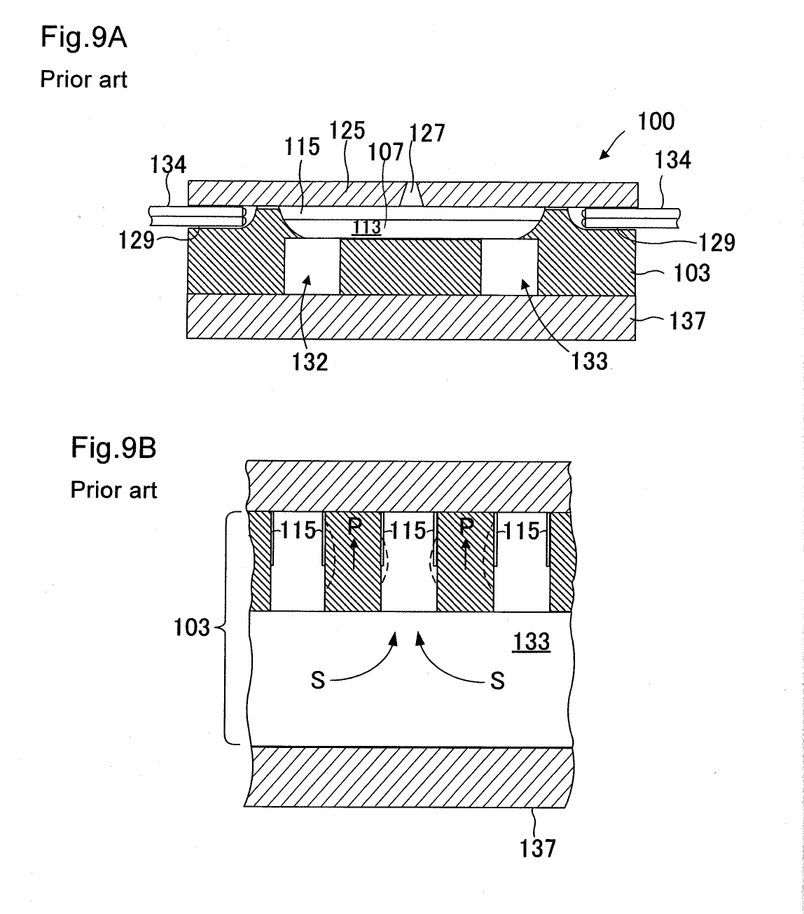

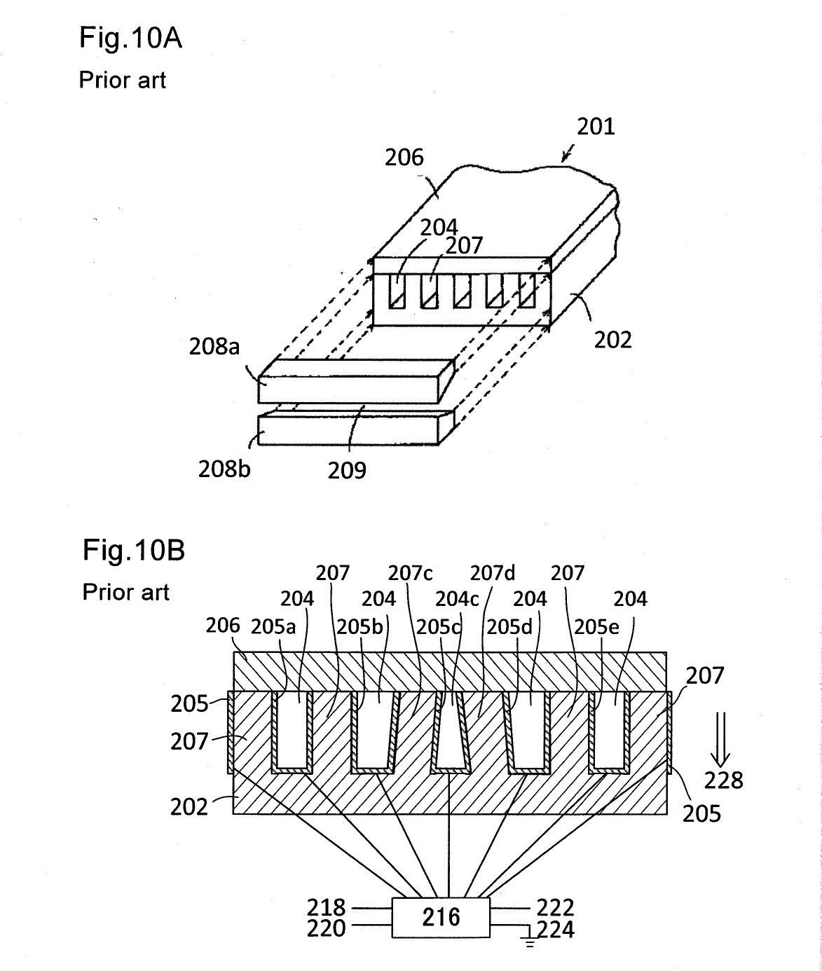

FIGS. 7A and 7B are cross-sectional schematic views of a liquid jet head 1 according to the fourth embodiment of the present invention. FIG. 7A is a cross-sectional schematic view of an ejection groove 6a in the longitudinal direction thereof. FIG. 7B is a cross-sectional schematic view of a non-ejection groove 6b in the longitudinal direction thereof. The difference from the first embodiment is that the liquid discharge chamber is not provided in the cover plate 3, and liquid supplied to the liquid supply chamber 9 is not circulated. The other configurations are substantially the same as those of the first embodiment. The same components or components having the same function are denoted by the same signs as those in the first embodiment.

As illustrated in FIGS. 7A and 7B, the liquid jet head 1 is provided with an actuator substrate 2, a cover plate 3 attached to an upper surface US of the actuator substrate 2, and a nozzle plate 4 attached to a lower surface LS of the actuator substrate 2. The actuator substrate 2 is partitioned by elongated walls 5 of piezoelectric body. A plurality of grooves 6 is arrayed in the actuator substrate 2. Each of the grooves 6 penetrates the actuator substrate 2 from the upper surface US through the lower surface LS and is elongated in the surface direction of the upper surface US or the lower surface LS. The cover plate 3 is attached to the actuator substrate 2 so as to cover upper surface openings 7 of the grooves 6, and has a liquid supply chamber 9 which supplies liquid to the grooves 6. The nozzle plate 4 is provided with nozzles 11 which communicate with the respective grooves 6, and attached to the actuator substrate 2 so as to cover lower surface openings 8 of the grooves 6. Further, common electrodes 12a and active electrodes 12b are formed in strip form on side surfaces of the walls 5 along the longitudinal direction thereof so as to be separated from the nozzle plate 4. The nozzle plate 4 has a lower stiffness than the cover plate 3.

The grooves 6 formed on the actuator substrate 2 include ejection grooves 6a and non-ejection grooves 6b, and the ejection grooves 6a and the non-ejection grooves 6b are alternately arrayed in parallel in a direction perpendicular to the longitudinal direction of the grooves 6 in the same manner as in the first embodiment. Further, the structures such as the shapes of the ejection grooves 6a and the non-ejection grooves 6b, and the positions of the ejection grooves 6a and the non-ejection grooves 6b on the actuator substrate 2 are the same as those of the first embodiment. Further, the common electrodes 12a formed on both side surfaces of the respective ejection grooves 6a, common terminals 16a electrically connected to the respective common electrodes 12a, the active electrodes 12b formed on both side surfaces of the respective non-ejection grooves 6b, and active terminals 16b connected to the respective active electrodes 12b are the same as those of the first embodiment.

The cover plate 3 is provided with the liquid supply chamber 9 at the second side of the actuator substrate 2. The liquid supply chamber 9 communicates with the ejection grooves 6a via second slits 14b, but does not communicate with the non-ejection grooves 6b. The cover plate 3 is adhered to the upper surface US of the actuator substrate 2 with adhesive. The nozzle plate 4 is adhered to the lower surface LS of the actuator substrate 2 with adhesive. The nozzles 11 which communicate with the respective ejection grooves 6a are formed on the nozzle plate 4. Each of the nozzles 11 is positioned closer to the first end from the center of each of the ejection grooves 6a in the longitudinal direction thereof. Each of the nozzles 11 may also be arranged on the center of each of the ejection grooves 6a. Liquid supplied to the liquid supply chamber 9 is filled into the ejection grooves 6a via the second slits 14b. Since the driving of the liquid jet head 1 is the same as that in the first embodiment, a description thereof will be omitted.

Further, the stiffness, the Young's modulus, and the thickness of the cover plate 3, and the stiffness, the Young's modulus, and the thickness of the nozzle plate 4 are the same as those of the first embodiment. Therefore, even when the nozzle plate 4 makes contact with a recording medium, the nozzle plate 4 does not easily bruise. Therefore, it is possible to prevent the occurrence of crosstalk. Further, since the common electrodes 12a and the active electrodes 12b are formed so as to be separated from the nozzle plate 4, liquid droplets are stably ejected from the nozzle 11.

### Fifth Embodiment

FIG. 8 is a schematic perspective view of a liquid jet apparatus 30 according to the fifth embodiment of the present invention. The liquid jet apparatus 30 is provided with a movement mechanism 40 which reciprocates liquid jet heads 1 and 1′, flow path sections 35 and 35′ which respectively supply liquid to the liquid jet heads 1 and 1′ and discharge liquid from the liquid jet heads 1 and 1′, liquid pumps 33 and 33′ which respectively communicate with the flow path sections 35 and 35′, and liquid tanks 34 and 34′. Each of the liquid jet heads 1 and 1′ is provided with a plurality of head chips, and each of the head chips is provided with a plurality of channels of ejection grooves. Each of the liquid jet heads 1 and 1′ ejects liquid droplets from nozzles that communicate with the respective channels. As the liquid pumps 33 and 33′, either or both of supply pumps which supply liquid to the flow path sections 35 and 35′ and discharge pumps which discharge liquid to components other than the flow path sections 35 and 35′ are provided. Further, a pressure sensor or a flow rate sensor (not illustrated) may be provided to control the flow rate of liquid. As each of the liquid jet heads 1 and 1′, any one of the liquid jet heads of the first to fourth embodiments is used.

The liquid jet apparatus 30 is provided with a pair of conveyance units 41 and 42 which conveys a recording medium 44 such as paper in a main scanning direction, the liquid jet heads 1 and 1′ each of which ejects liquid onto the recording medium 44, a carriage unit 43 on which the liquid jet heads 1 and 1′ are loaded, the liquid pumps 33 and 33′ which respectively supply liquid stored in the liquid tanks 34 and 34′ to the flow path sections 35 and 35′ by pressing, and the movement mechanism 40 which moves the liquid jet heads 1 and 1′ in a sub-scanning direction that is perpendicular to the main scanning direction. A control unit (not illustrated) controls the liquid jet heads 1 and 1′, the movement mechanism 40, and the conveyance units 41 and 42 to drive.

Each of the pair of conveyance units 41 and 42 extends in the sub-scanning direction, and includes a grid roller and a pinch roller which rotate with the roller surfaces thereof making contact with each other. The grid roller and the pinch roller are rotated around the respective axes by a motor (not illustrated) to thereby convey the recording medium 44, which is sandwiched between the rollers, in the main scanning direction. The movement mechanism 40 is provided with a pair of guide rails 36 and 37 each of which extends in the sub-scanning direction, the carriage unit 43 which can slide along the pair of guide rails 36 and 37, an endless belt 38 to which the carriage unit 43 is coupled to move the carriage unit 43 in the sub-scanning direction, and a motor 39 which revolves the endless belt 38 via a pulley (not illustrated).

The carriage unit 43 loads the plurality of liquid jet heads 1 and 1′ thereon. The liquid jet heads 1 and 1′ eject, for example, respective four colors of liquid droplets including yellow, magenta, cyan, and black. Each of the liquid tanks 34 and 34′ stores liquid of corresponding color, and supplies the stored liquid to each of the liquid jet heads 1 and 1′ through each of the liquid pumps 33 and 33′ and each of the flow path sections 35 and 35′. Each of the liquid jet heads 1 and 1′ ejects liquid droplets of corresponding color in response to a driving signal. Any patterns can be recorded on the recording medium 44 by controlling the timing of ejecting liquid from the liquid jet heads 1 and 1′, the rotation of the motor 39 for driving the carriage unit 43, and the conveyance speed of the recording medium 44.

In the liquid jet apparatus 30 of the present embodiment, the movement mechanism 40 moves the carriage unit 43 and the recording medium 44 to perform recording. Alternatively, however, the liquid jet apparatus may have a configuration in which a carriage unit is fixed, and a movement mechanism two-dimensionally moves a recording medium to perform recording. That is, the movement mechanism may have any configuration as long as it can relatively move a liquid jet head and a recording medium.

What is claimed is:

1. A liquid jet head comprising:
an actuator substrate partitioned by elongated walls of piezoelectric body, the actuator substrate having a plurality of elongated grooves arrayed thereon so as to penetrate the actuator substrate from an upper surface through a lower surface thereof;
a cover plate attached to the actuator substrate so as to cover upper surface openings of the grooves, the cover plate having a liquid supply chamber configured to supply liquid to the grooves; and
a nozzle plate attached to the actuator substrate so as to cover lower surface openings of the grooves, the nozzle plate having nozzles communicating with the grooves,
wherein drive electrodes are formed in strip form on side surfaces of the walls along the longitudinal direction thereof so as to be separated from the nozzle plate, and
the nozzle plate has a lower stiffness than the cover plate.

2. The liquid jet head according to claim 1, wherein a material of the nozzle plate has a lower stiffness than a material of the cover plate.

3. The liquid jet head according to claim 1, wherein the nozzle plate includes a material having a Young's modulus in the range of 1.5 GPa to 30 GPa.

4. The liquid jet head according to claim 1, wherein the cover plate includes a material having a Young's modulus of not less than 40 GPa.

5. The liquid jet head according to claim 1, wherein the cover plate has a thickness in the range of 0.3 mm to 1.0 mm, and the nozzle plate has a thickness in the range of 0.01 mm to 0.1 mm.

6. The liquid jet head according to claim 1, wherein the nozzle plate has a laminate structure of a polyimide film and a reinforcing plate having a higher stiffness than the polyimide film.

7. The liquid jet head according to claim 1, wherein the cover plate includes a liquid discharge chamber configured to discharge liquid from the grooves, the liquid discharge chamber communicates with each of the grooves on one side in the longitudinal direction thereof, and the liquid supply chamber communicates with each of the grooves on the other side in the longitudinal direction thereof.

8. The liquid jet head according to claim 1, wherein the grooves include an ejection groove and a non-ejection groove which are alternately arrayed, and
the liquid supply chamber communicates with the ejection groove and does not communicate with the non-ejection groove.

9. The liquid jet head according to claim 7, wherein the grooves include an ejection groove and a non-ejection groove which are alternately arrayed, and
the liquid discharge chamber communicates with the ejection groove and does not communicate with the non-ejection groove.

10. A liquid jet apparatus comprising:
the liquid jet head according to claim 1;
a movement mechanism configured to relatively move the liquid jet head and a recording medium;
a liquid supply tube configured to supply liquid to the liquid jet head; and
a liquid tank configured to supply the liquid to the liquid supply tube.
